(19) United States
(12) Patent Application Publication
(10) Pub. No.: US 2019/0161926 A1
(43) Pub. Date: May 30, 2019

(54) LIFE SAVER DEVICE AND METHOD

(71) Applicant: Bryan Wiesen, Ranger, TX (US)

(72) Inventor: Bryan Wiesen, Ranger, TX (US)

(21) Appl. No.: 16/184,325

(22) Filed: Nov. 8, 2018

Related U.S. Application Data
(60) Provisional application No. 62/591,640, filed on Nov. 28, 2017.

(51) Int. Cl. E01F 9/615; E01F 9/692; E01F 9/654; G08G 1/0955

(52) U.S. Cl. CPC E01F 9/617; E01F 9/692; E01F 9/70; G08G 1/0955; E01F 9/654

(57) ABSTRACT

A life saver device includes a traffic cone having an internal volume, a bottom closure panel, a rechargeable battery and at least one light and may further comprise an internal volume with a bottom closure panel to house a rechargeable battery for powering at least one light; and is configured to provide a portable, rechargeable, illuminated traffic safety alert signal.

### CROSS-REFERENCE TO RELATED APPLICATION(S)

The present application is related to and claims priority to U.S. Provisional Patent Application No. 62/591,640 filed Nov. 28, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of traffic warning devices of existing art and more specifically relates to traffic cones.

### RELATED ART

Many individuals drive in modern society. Drivers may not see disabled vehicles, construction or utility workers, mechanics, first responders, and others on the side of the road, due to distractions, the time of day, bad weather conditions, and more. Unfortunately, this often results in fatal collisions or serious injuries which is not desirable. A tow truck or roadside service vehicle typically has amber colored warning lights on it for alerting traffic of a disabled vehicle, but the lights on a tow truck or service vehicle cannot by law be red and blue. Additionally, the tow truck or service vehicle may be in front of the disabled vehicle further reducing the visibility of the amber warning lights. Commonly the service vehicle operator may need to be on the other end of the disabled vehicle away from the warning lights. Typically, orange traffic cones are commonly placed on the roadway leading up to the disabled vehicle to warn and hopefully divert traffic away from the disabled vehicle to provide a safer working zone for the service vehicle operator.

Conventional orange traffic cones may or may not have a reflective stripe for additional visibility at night when struck by the head lights of an on-coming vehicle. This reflective stripe has little of no effect during daylight hours. Furthermore, standard traffic cones combined with the amber lights of the service vehicle only serves to send a (slow down) signal to another vehicle operator.

Conversely, emergency and first responder vehicles have red and blue flashing lights. These red and blue flashing lights serve not only as a warning signal to slow down, but also signal approaching traffic to move over as far as possible to provide a safety working zone for critical traffic areas. The current commonly used system often requires police or emergency response vehicles to remain on scene when a disabled vehicle requires towing or maintenance such as fuel delivery and/or tire changing in a critical traffic area to provide safety for the service vehicle operator. A suitable solution is desired.

U.S. Pat. No. 8,602,584 to Joel Timothy Morgan relates to a traffic cone. The described cone light includes a cone light is a light emitting structure that is placed on a traffic cone to improve the visibility of the traffic cone. The light cone includes a plurality of lights that are mounted to an outer surface of the cone light and a micro-controller that controls the illumination of the lights. The cone light also has a memory storing a plurality of flash patterns and the micro-controller illuminates the lights in the flash pattern selected by the user. Multiple cone lights can be used together with a master cone light transmitting a flash pattern signal to one or more slave cone light so that each of the cone lights is illuminated in a matching or coordinated pattern.

### SUMMARY OF THE INVENTION

In view of the foregoing disadvantages inherent in the known traffic warning devices art, the present disclosure provides a novel life saver device. The general purpose of the present disclosure, which will be described subsequently in greater detail, is to provide an efficient and effective life saver device.

A life saver device is disclosed herein. The life saver device includes a traffic cone having an internal volume, a bottom closure panel, a rechargeable battery and at least one light and may further comprise an internal volume with a bottom closure panel to house a rechargeable battery for powering at least one light. As such the present invention is configured to provide a portable, rechargeable, illuminated traffic safety alert signal.

According to another embodiment, a method of use for a life saver device is also disclosed herein. The method includes a providing a life saver device, placing the life saver device, activating the life saver device, preforming a work task, retrieving the life saver device, deactivating the life saver device and coupling the device to auxiliary charging power source.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a life saver device, constructed and operative according to the teachings of the present disclosure.

FIG. 1 is a perspective view of the life saver device during an ‘in-use’ condition, according to an embodiment of the disclosure.

FIG. 2 is a cut-away view of the life saver device of FIG. 1, according to an embodiment of the present disclosure.

FIG. 3 is a perspective view of the life saver device of FIG. 1, according to an embodiment of the present disclosure.

FIG. 4 is a flow chart view of the life saver device control module of FIG. 2, according to an embodiment of the present disclosure.

FIG. 5 is a flow diagram illustrating a method of use for the life saver device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to traffic warning devices and more particularly to a life saver device as used to improve the device.

Generally, the life saver device of the present disclosure is an improvement of the current commonly used system. The life saver device of the present disclosure provides a traffic cone that may include a plurality of lights which may include red and blue colored flashing lights and an operating system with a rechargeable battery. The device may further include a wireless activation control module. The device is configured to provide a portable, rechargeable, illuminated traffic safety alert signal.

When a service vehicle operator (user) arrives on the scene of a disabled vehicle the operator (user) may place the life saver device(s) on or near the roadway at a preferred location to establish a safe working perimeter. The service vehicle operator (user) may activate the device(s) manually with a power switch affixed to the exterior of the device, or via programmable wireless protocol. By activating the red and blue flashing lights the service vehicle operator (user) is able make sure other vehicle operators are alerted to slow down and move away from a disabled vehicle requiring service or removal.

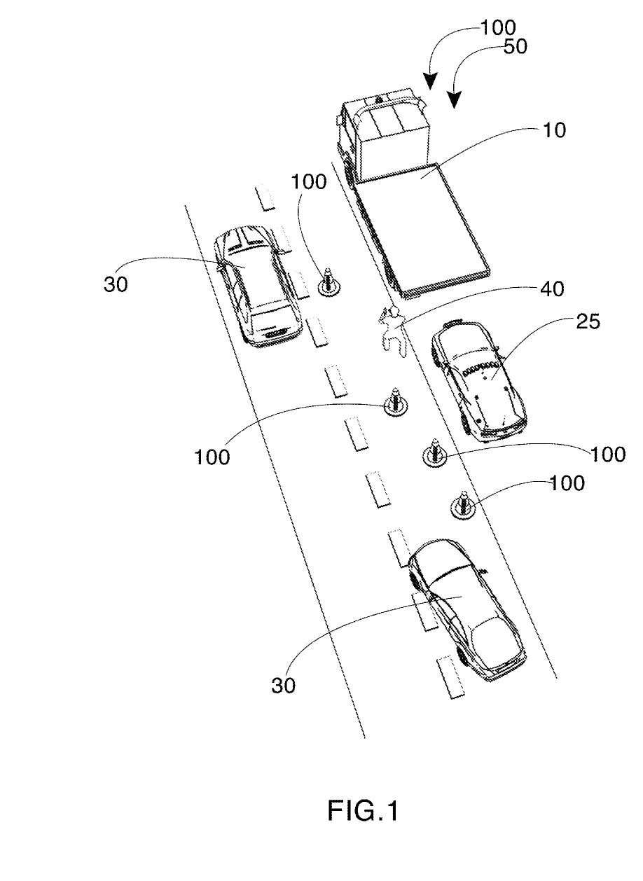

Referring now more specifically to the drawings by numerals of reference, there is shown in FIGS. 1-4, various views of a life saver device 100.

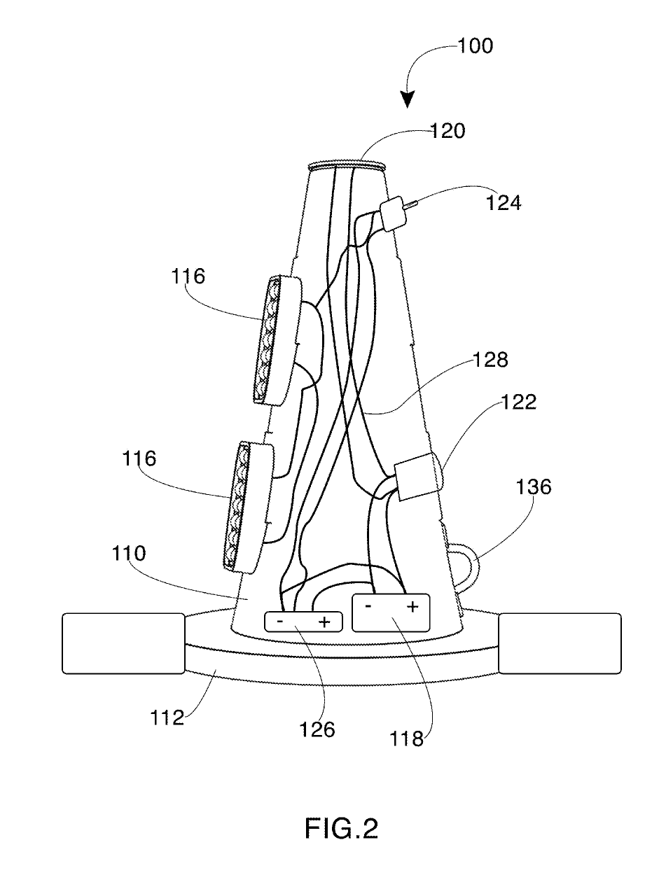

FIG. 1 shows a life saver device 100 during an ‘in-use’ condition 50, according to an embodiment of the present disclosure. Here, the life saver device 100 may be beneficial for use by a user 40 to provide a portable, rechargeable, illuminated traffic safety alert signal. As illustrated, the life saver device 100 may include a plurality of life saver devices 100 each comprising a traffic cone having; a rechargeable battery 114, and at least one light 116 and a power switch 124. The devices 100 further may include an internal volume 110 with a bottom closure panel 112 to house the rechargeable battery 114 for powering at least one light 116 configured to provide a portable, rechargeable, illuminated traffic safety alert signal. The structure of the life saver device 100 as disclosed is shown in detail in FIG. 2.

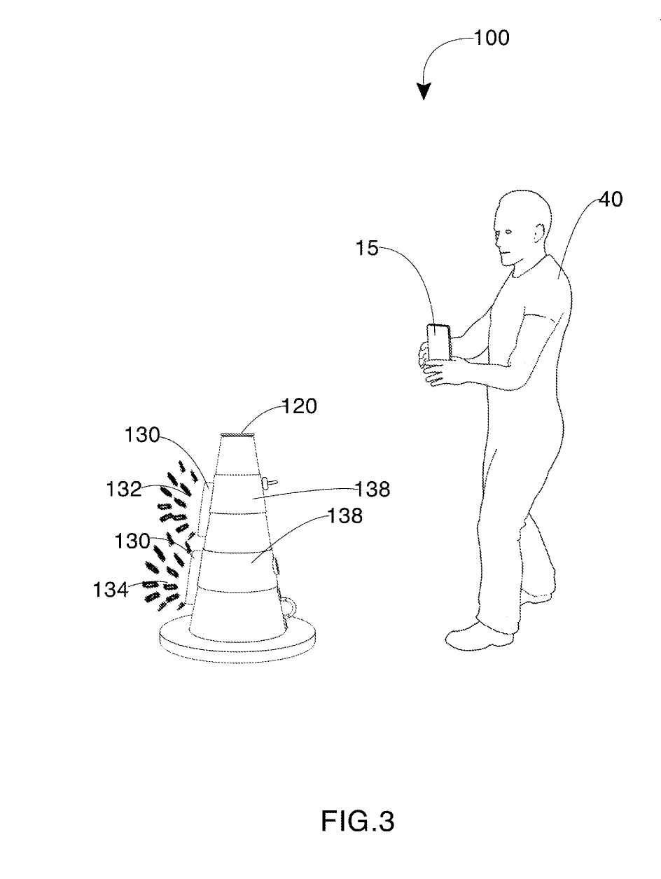

As shown ‘in-use’ a service vehicle 10, such as a tow truck for example may park in front of the disabled vehicle 25, the tow truck operator (user) 40 may use a plurality of life saver devices 100 to divert the flow of traffic away from the scene of an accident or disabled vehicle 25 to establish a safe work area. The user 40 may activate the life saver device by toggling a manual power switch 124 or by wireless communication as disclosed in FIG. 3.

Further shown in FIG. 1 the user 40 may place at least one life saver device 100 at a preferred distance behind a disabled vehicle 25. A plurality of life saver devices 100 may also be placed progressively into a traffic lane to divert on-coming traffic away from the disabled vehicle 25 and the service vehicle 10 to provide a safe work zone for the user 40 to perform necessary duties.

According to one embodiment, the life saver device 100 may be arranged as a kit 105. In particular, the life saver device 100 may further include a set of instructions 107. The instructions 107 may detail functional relationships in relation to the structure of the life saver device 100 such that the life saver device 100 can be used, maintained, or the like, in a preferred manner.

FIG. 2 is a cut-away view of the life saver device 100 of FIG. 1, according to an embodiment of the present disclosure. As above, the life saver device 100 may be a traffic cone having a rechargeable battery housed in the internal volume of a life saver device 100. The rechargeable battery 118 may be coupled to a solar panel 120 affixed to the external surface of the life saver device 100 to provide a means of charging the rechargeable battery 118 during day-light hours.

The life saver device 100 may further comprise a charge port 122. The charge port 122 may be configured to be couplable to a service vehicle 10 charging system for recharging the rechargeable battery 118 when being transported by a service vehicle 10. The rechargeable battery 118 preferably has a 12-volt capacity capable of powering typical vehicle lighting systems. Other embodiments may comprise non-rechargeable batteries, dry cell battery or other batteries compatible with a 120-volt a/c-d/c charging system. The device may further include a bottom closure panel 112. The bottom closure panel 112 may be removable or hinged to provide access to the internal volume 110. Preferably the bottom closure panel 112 may be configured to provide a waterproof access opening for servicing the components housed within the internal volume 110. Additionally, a handle may be affixed to the exterior of the life saver device 100 to provide easier handling of the life saver device 100 by the user 40. Furthermore, the life saver device 100 may include reflective marking 138 for improved visibility in low light conditions.

Furthermore, it should be noted that although not illustrated the charge port 122 may be utilized as a direct wiring circuit 128 coupling to the service vehicle's 10 electrical system in the event of a total battery 118 failure. A battery-less embodiment of the life saver device 100 may also be envisioned and will be understood by those knowledgeable in such art.

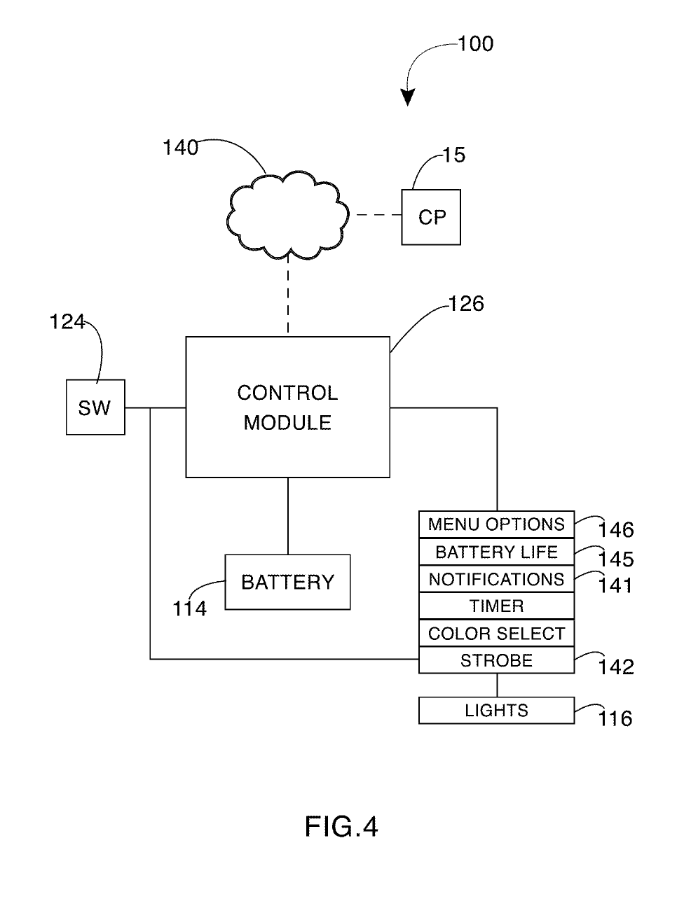

According to an embodiment of the present disclosure. The life saver device 100 may further comprises a power switch 124 accessible on the exterior of the life saver device 100. Additionally, an electronic control module 126 shown in detail in FIG. 4 is housed in the internal volume 110. As shown here in FIG. 2 a wiring circuit 128 provides electrical communication between the rechargeable battery 118, the control module 126, the power switch 124, the solar panel 120, the charge port 122 and the at least one light 116.

Further referring to FIG. 2 an embodiment of the life saver device 100 may include a plurality of LED lights 116. The preferred embodiment may include at least one red 132 LED light and at least one blue 134 LED light as illustrated in FIG. 3. Still other embodiments may further include additional color lights such as but not limited to amber and white.

FIG. 3 is a perspective view of the life saver device 100 of FIG. 1, according to an embodiment of the present disclosure. As above the life saver device 100 comprising a traffic cone having a solar panel 120 affixed to the external surface of the life saver device 100 to charge the rechargeable battery 118 during day-light hours. As shown the solar panel 120 is a top cap, however other embodiments may comprise solar strips placed vertically or circumferentially on the exterior of the device 100. In still another embodiment the solar panels 120 may be integrated with reflective markings 138.

The device of the present disclosure may further include colored lights 130. In an embodiment of the life saver device 100, red 132 and blue 134 LED light may be utilized. Upon reading this specification, it should be appreciated that, under appropriate circumstances, considering such issues as user preferences, design preference, structural requirements, marketing preferences, cost, available materials, technological advances, etc., other light 130 arrangements such as, for example, colors, shape, size, etc., may be sufficient.

A control module 126 shown in FIGS. 2 & 4 includes programmable wireless activation interface 140. The wireless activation interface 140 further includes a user alert protocol 141. The wireless activation interface 140 provides communication with the life saver device 100 from the user 40 via a blue-tooth device such as cell phone 15 or a communication device within the service vehicle 10 not illustrated. The user alert protocol 141 may be useful to notify the user 40 in the even that a life saver device 100 was left behind when leaving the scene. Additionally, the user alert protocol 141 may further notify the user 40 when a life saver device 100 has malfunctioned.

FIG. 4 is a flow chart view of the life saver device's 100 control module 126 of FIG. 2, according to an embodiment of the present disclosure. As above the life saver device 100 may include a control module 126 housed within the internal volume 110 as shown in FIG. 2. According to another embodiment the control module 126 may comprise a weather proof housing affixed to the exterior of the life saver device 100.

Although not illustrated in an embodiment of the control module 126, the control module 126 may further include a display screen and a plurality of function selection keys. In functional combination this configuration may provide a means for manual operation of the life saver device 100 without the use of wireless activation interface 140. It should be noted that each embodiment may include a power switch 124 affixed to the exterior of the life saver device. The power switch 124 may further include a wire circuit 128 as shown in FIG. 2, capable of bypassing undesired parameters of the control module 126 to provide basic operation of the life saver device 100. Furthermore, the rechargeable battery 144 provide pa power source for the control module 126.

The control module 126 as shown in here in FIG. 4 may be configured to provide a plurality of functions. Functions may include but not be limited to wireless activation interface 140, menu options 146, battery life 145, user alert protocol 141, a strobe circuit 142, lights 116 activation and other examples may include a time or light color selection.

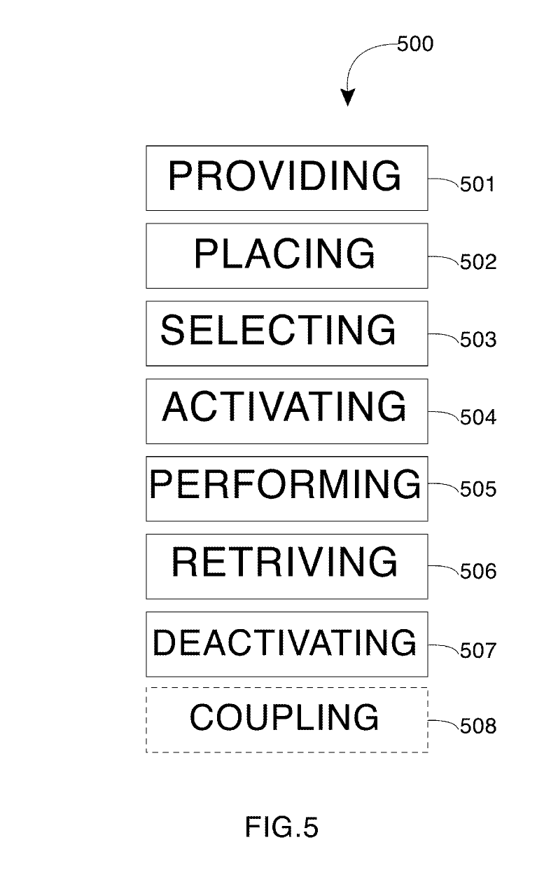

FIG. 5 is a flow diagram illustrating a method for life saver device 100, according to an embodiment of the present disclosure. In particular, the method of use 500 for a life saver device 100 may include one or more components or features of the life saver device 100 as described above. As illustrated, the method of use 500 for a life saver device 100 may include the steps of: step one 501, providing a traffic cone having; an internal volume, a rechargeable battery 114, and at least one light 116 and a power switch 124. The device 100 further may include an internal volume 110 with a bottom closure panel 112 to house the rechargeable battery 114 for powering at least one light 116 configured to provide a portable, rechargeable, illuminated traffic safety alert signal; step two 502, placing at least one device 100 on a perimeter, alternatively as shown in FIG. 1 a service vehicle 10, such as a tow truck for example may park in front of the disabled vehicle 25, the tow truck operator (user) 40 may use a plurality of life saver devices 100 to divert the flow of traffic away from the scene of an accident or disabled vehicle 25 to establish a safe work area; step three 503, selecting a signal sequence as above the user 40 may use a cell phone to access the programmable wireless activation interface 140 and select menu options 146 to scroll through a plurality of functions to select a preferred signal sequence such as strobe and light color for example; step four 504, activating the device 100. The user 40 may activate the device in at least three ways, a first method of activation may be via the programmable wireless activation interface 140. A second method of activation may include an embodiment of the control module 126 comprising a weather proof housing affixed to the exterior of the life saver device 100 including a display screen and a plurality of function selection keys. In functional combination this configuration may provide a means for manual operation of the life saver device 100 without the use of wireless activation interface 140 and a third method of activation may include a power switch 124 affixed to the exterior of the life saver device. The power switch 124 may further include a wire circuit 128 as shown in FIG. 2, capable of bypassing undesired parameters of the control module 126 to provide basic operation of the life saver device 100; step five 505, performing work task such as loading a disabled vehicle 35 to be towed, maintenance, fuel delivery and/or tire changing; step six 506, retrieving the device(s) 100 once the work task has been completed; step seven 507, deactivating the device via whichever method may have been used to activate the device 100 as stated in step four 504 or any combination thereof; step eight 508, coupling the device to auxiliary charging power source via the charge port 122 configured to be couplable to a service vehicle 10 charging system for recharging the rechargeable battery 118 when being transported by a service vehicle 10.

It should be noted that step eight 508, is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of the life saver device are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A life saver device, the device comprising:
a traffic cone having;
an internal volume;
a bottom closure panel;
a rechargeable battery;
and
at least one light,
wherein said traffic cone an internal volume with a bottom closure panel to house said rechargeable battery for powering said at least one light and is configured to provide a portable, rechargeable, illuminated traffic safety alert signal.

2. The device of claim 1, wherein said rechargeable battery is housed in said internal volume and coupled to a solar panel affixed to the external surface of said traffic cone to charge said rechargeable battery during day-light hours.

3. The device of claim 1, wherein said traffic cone further comprising a charge port; and
wherein said charge port is configured to be couplable to a vehicle charging system for recharging said rechargeable battery when in transport.

4. The device of claim 1, wherein said bottom closure panel is removable to provide access to said internal volume.

5. The device of claim 1, wherein the said rechargeable battery has a 12-volt capacity capable of powering typical vehicle lighting systems.

6. The device of claim 1, wherein the said traffic cone further comprises a power switch accessible on the exterior of said traffic cone.

7. The device of claim 1, wherein an electronic control module is housed in said internal volume.

8. The device of claim 1, wherein a wiring circuit provides electrical communication between said rechargeable battery, said control module, said power switch, said solar panel, said charge port and said at least one light.

9. The device of claim 7, wherein said control module includes programmable wireless activation interface.

10. The device of claim 9, wherein said wireless activation interface includes a user alert protocol.

11. The device of claim 7, wherein said control module includes a strobe circuit interface.

12. The device of claim 1, wherein said at least one light is LED.

13. The device of claim 12, wherein said LED is red.

14. The device of claim 12, wherein said LED is blue.

15. The device of claim 1, wherein a handle is affixed to the exterior of said traffic cone.

16. The device of claim 1, wherein said traffic cone includes reflective markings.

17. A life saver device, the device comprising: a traffic cone having;
a bottom closure panel;
a rechargeable battery;
and
at least one light,
wherein said traffic cone has an internal volume with a bottom closure panel to house said rechargeable battery for powering said at least one light and is configured to provide a portable, rechargeable, illuminated traffic safety alert signal.
wherein said rechargeable battery is house in said internal volume and coupled to a solar panel affixed to the external surface of said traffic cone to charge said rechargeable battery during day-light hours;
wherein said traffic cone further comprising a charge port;
wherein said charge port is configured to be couplable to a vehicle charging system for recharging said rechargeable battery when in transport;
wherein said bottom closure panel is removable to provide access to said internal volume;
wherein said rechargeable battery has a 12-volt capacity capable of powering typical vehicle lighting systems;
wherein the said traffic cone further comprises a power switch accessible on the exterior of said traffic cone;
wherein an electronic control module is housed in said internal volume;
wherein a wiring circuit provides electrical communication between said rechargeable battery, said control module, said power switch, said solar panel, said charge port and said at least one light;
wherein said control module includes programmable wireless activation interface;
wherein said wireless activation interface includes a user alert protocol;
wherein said control module includes a strobe circuit interface;
wherein said at least one light is LED;
wherein said LED is red;
wherein said LED is blue;
wherein a handle is affixed to the exterior of said traffic cone; and
wherein said traffic cone includes reflective markings.

18. The device of claim 17, further comprising set of instructions; and
wherein the device is arranged as a kit.

19. A method of use, for a life saver device, the method comprising the steps of:
providing a traffic cone having; an internal volume, a bottom closure panel, a rechargeable battery and at least one light; wherein said traffic cone has said internal volume with said bottom closure panel to house said rechargeable battery for powering said at least one light and is configured to provide a portable, rechargeable, illuminated traffic safety alert signal;
placing at least one device on a perimeter;
selecting a signal sequence;
activating the device;
performing work task;
retrieving the device; and
deactivating the device;

20. The method of claim 19, further comprising the step of:
coupling the device to an auxiliary charging power source.
